(19) United States
(12) Patent Application Publication
(10) Pub. No.: US 2008/0147411 A1
(43) Pub. Date: Jun. 19, 2008

(54) ADAPTATION OF A SPEECH PROCESSING SYSTEM FROM EXTERNAL INPUT THAT IS NOT DIRECTLY RELATED TO SOUNDS IN AN OPERATIONAL ACOUSTIC ENVIRONMENT

(75) Inventors: DWAYNE DAMES, BOYNTON BEACH, FL (US); FELIPE GOMEZ, WESTON, FL (US); BRENT D. METZ, DELRAY BEACH, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/612,722

(22) Filed: Dec. 19, 2006

(51) Int. Cl. G10L 21/00

(52) U.S. Cl. 704/275

(57) ABSTRACT

A speech processing system that performs adaptations based upon non-sound external input, such as weather input. In the system, an acoustic environment can include a microphone and speaker. The microphone/speaker can receive/produce speech input/output to/from a speech processing system. An external input processor can receive non-sound input relating to the acoustic environment and to match the received input to a related profile. A setting adjustor can automatically adjust settings of the speech processing system based upon a profile based upon input processed by the external input processor. For example, the settings can include customized noise filtering algorithms, recognition confidence thresholds, output energy levels, and/or transducer gain settings.

### BACKGROUND

1. Field of the Invention

The present invention relates to the field of speech processing, and, more particularly, to the adaptation of a speech processing system from external input that is not directly related to sounds in the operational acoustic environment.

2. Description of the Related Art

Speech processing systems utilize various sound-based inputs to adjust speech application settings and audio characteristics of a speech processing environment. For example, speech input can be analyzed to determine a speaker's language dialect, and/or gender while speech recognition settings (e.g., language) can be adjusted based upon the results of the analysis. In another example, the ambient noise of an acoustic environment can be sampled and used to adjust additional settings, such as microphone sensitivity and speaker volume. Further, inputs from multiple directional microphones can be utilized to capture sounds and digital signal processing techniques, such as filtering and noise reduction, and can also be used to preprocess captured input before speech recognition actions are performed.

Despite the breadth of adjustments that can be made based upon sounds occurring within the acoustic environment of a speech recognition system, non-sound input of the acoustic environment are conventionally ignored. Often, these non-sound inputs can have a greater effect on a speech processing system or a user's experience with such a system than sound-based factors. Weather and/or user-specific factors, for example, can have a significant affect on a user's experience with a speech processing system.

For instance, if a user is standing in the rain using a speech-enabled Automated Teller Machine (ATM), verbose prompts including robust but seldom used options can be highly aggravating to a water-logged user attempting to perform a quick transaction. Additionally, optimal acoustic settings can be very different for rainy environments than for clear ones; transducer performance is especially affected by weather conditions. Weather can also affect the ambient noise characteristics of a speech processing environment. For example, higher wind strengths can interfere with the capturing of a user's speech commands as well as create an overpowering amount of background noise.

What is needed is a means to capture external input in various forms and to use this input to adjust the speech application settings and/or acoustic model associated with a speech processing system. Ideally, such a solution would collect different types of pertinent data from a variety of sources for a specific acoustic environment. That is, the conditions within the operational acoustic environment housing a speech processing system would be detected in order to adjust the system to provide optimal service.

### SUMMARY OF THE INVENTION

The present invention provides a solution that automatically adapts characteristics of a speech processing system based upon external input, such as weather. The external input can include input other than direct sound input, such as ambient noise, which some conventional speech processing systems utilize for sound level adjustment purposes. As used herein, the external input can include any condition that affects a user's interactive experience with a speech processing system, such as user location, a heart rate of a user, a length of a waiting queue to use the system, the weather conditions affecting the system, and the like. For example, the invention can permit a speech processing system to incorporate weather information from a current environment and to dynamically utilize specialized acoustic models and system recognition thresholds that are tailored for the detected weather conditions (e.g., sunny, windy, rainy, stormy, and the like) thereby optimizing system performance in accordance with the current weather conditions.

The present invention can be implemented in accordance with numerous aspects consistent with material presented herein. For example, one aspect of the present invention can include a speech processing system that performs adaptations based upon non-sound external input, such as weather input. In the system, an acoustic environment can include a microphone and speaker. The microphone/speaker can receive/produce speech input/output to/from a speech processing system. An external input processor can receive non-sound input relating to the acoustic environment and to match the received input to a related profile. A setting adjustor can automatically adjust settings of the speech processing system based upon a profile based upon input processed by the external input processor. For example, the settings can include customized noise filtering algorithms, recognition confidence thresholds, output energy levels, and/or transducer gain settings.

Another aspect of the present invention can include a method for adapting speech processing settings. The method can include a step of receiving real-time input associated with at least one of an acoustic environment and a user of a speech processing system. The real-time input can be non-speech input. A previously established profile can be determined form a set of profiles that matches the received input. The profile can be associated with at least one setting of the speech processing system. The speech processing system can be dynamically and automatically adjusted in accordance with the settings of the determined profile.

Still another aspect of the present invention can include a method for automatically adjusting settings of a speech processing system. In the method, at least one weather condition can be determined that affects an acoustic environment from which speech input for a speech processing system is received. At least one setting of the speech processing system can be automatically adjusted to optimize the system in accordance with the determined weather condition.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a speech processing system that can adapt operations based on external inputs that are not directly related to environmental sounds in accordance with an embodiment of the inventive arrangements disclosed herein.

FIG. 2 is a flow chart of a method in which a speech processing system can adjust operations based on external inputs in accordance with an embodiment of the inventive arrangements disclosed herein.

FIG. 3 is a graphical representation illustrating how a speech processing system can use external inputs to adjust operations in accordance with an embodiment of the inventive arrangements disclosed herein.

FIG. 4 is a flow chart of a method where a service agent can configure a speech processing system to adapt its operation based on external inputs that are not directly related to environmental sounds in accordance with an embodiment of the inventive arrangements disclosed herein.

### DETAILED DESCRIPTION OF THE INVENTION

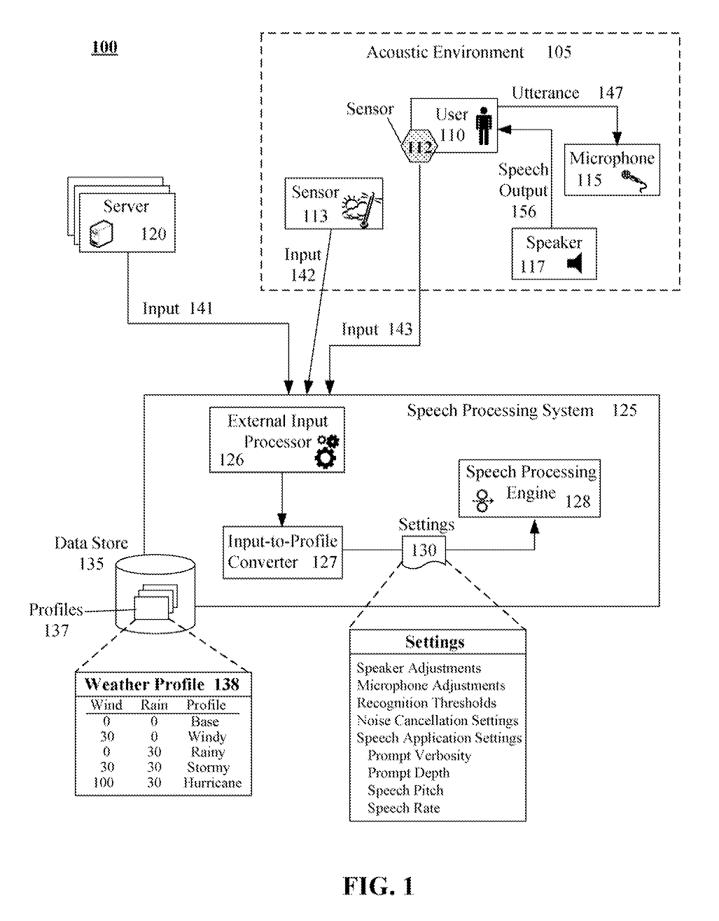

FIG. 1 is a schematic diagram of a speech processing system 125 that can adapt operations based on external inputs that are not directly related to environmental sounds in accordance with an embodiment of the inventive arrangements disclosed herein. In FIG. 1, a user 110 can interact with speech processing system 125. The user 110 can be located within an acoustic environment 105 that can contain sensors 112 and 113, a microphone 115, and a speaker 117. In one contemplated configuration, the microphone 115 and speaker 117 can be integrated into a housing that contains the speech processing system 125.

The sensor 112, possessed by or located on the user 110, can collect data about the user 110 and transmit this data as input 143 to the speech processing system 125. For example, a speech-enabled handset (i.e., system 125) can detect a BLUETOOTH headset is in use for presenting output. Input 142 indicating this system condition can be conveyed to system 125, which can automatically modify output characteristics accordingly. In another example, the sensor 112 can determine a user's pulse rate or provide other philological input 143 to system 125, which makes adjustments based on the input 143.

The other sensor 113 that is located in the acoustic environment 105 can collect environmental data, such as wind speed or barometric pressure, and transmit the data as input 142 to the speech processing system 125. The speech processing system 125 can also receive input 141 form one or more servers 120. These servers 120 can provide the system 125 with a variety of data, such as locally reported weather conditions, satellite radar maps, profile specific information related to user 110, and the like.

The inputs 141, 142, and 143 can be processed by the external input processor 126 of the speech processing system 125. The external input processor 126 can execute software code to identify pertinent data relating to the current conditions existing in the acoustic environment 105. Once the inputs 141, 142, and 143 have been processed, the external input processor 126 can invoke the input-to-profile converter 127.

The input-to-profile converter 127 can access the profiles 137 contained in a data store 135 and determine which should be initiated based on the processed inputs 141-143. For example, receipt of input pertaining to local weather conditions can cause the input-to-profile converter 127 to access a weather profile 138. As shown in this example, the weather profile 138 can contain values of pertinent weather conditions, such as wind and rain, and an associated setting profile to use based on the processed external input. It should be noted that the contents shown in the weather profile 138 are for illustrative purposes only and are not meant to convey a limitation of the present invention.

After determining which profiles 137 are applicable to the conditions of the acoustic environment 105, the input-to-profile converter 127 can pass the settings 130 associated with the determined profile(s) 137 to the speech processing engine 128. As shown in this example, the settings 130 can include items such as speaker adjustments, microphone adjustments, recognition thresholds, noise cancellation settings, speech application settings, and the like. These settings 130 can be enacted by the speech processing engine 128 for the associated components of the speech processing system 125.

In one arrangement, multiple profiles 137 can be enabled or active at any one time for the system 125, which can result in multiple adjustments being made. For example, a “rainy” profile 137 and a “rushed user” profile 137 can both be enabled in a scenario where a user having a high pulse rate (input 143) is using a system 125 in rainy weather. Further, sound-based conditions can be combined with other input 141-143 to produce a more accurate profile 137 and/or to further optimize system 125. For example, a speaking rate of user 110 can be a factor in determining whether user 110 is in an excited or relaxed state. In another example, ambient sound samplings from environment 105 can be combined with weather input 141-142 to optimize gain and other transducer 115-117 settings for environment 105 conditions.

The adjustments made by the speech processing system 125 can affect how the system receives and processes an utterance 147 and/or can affect how speech output 156 is presented. For example, windy conditions can cause the system 125 to increase the sensitivity of the microphone 115 to capture the utterance 147. Additionally, the volume of the speaker 117 that provides speech output 156 to the user 110 can also be adjusted to compensate for the windy conditions.

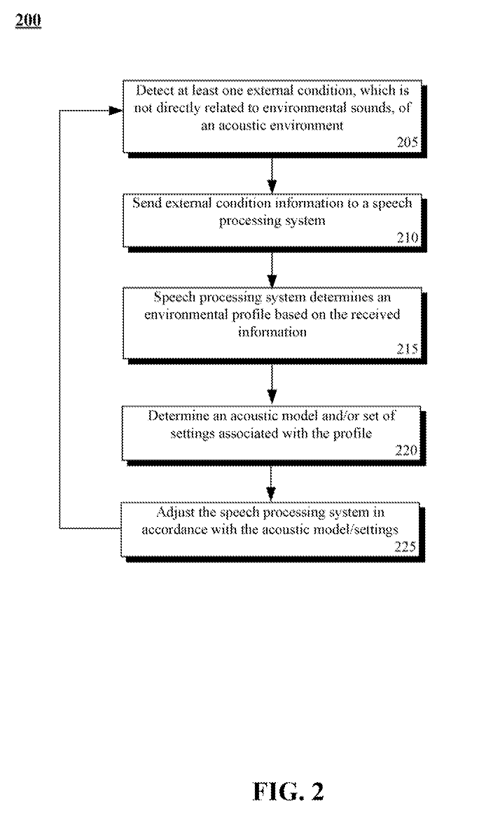

FIG. 2 is a flow chart of a method 200 in which a speech processing system can adjust operations based on external inputs in accordance with an embodiment of the inventive arrangements disclosed herein. Method 200 can be performed in the context of a system 100.

Method 200 can begin in step 205, where at least one external condition that is not directly related to environmental sounds can be detected in an acoustic environment. In step 210, the detected external condition information can be sent to a speech processing system. The speech processing system can determine an environmental profile based on the received information in step 215.

In step 220, an acoustic model and/or set of settings associated with the profile can be determined. The speech processing system, in step 225, can adjust the necessary settings based on the determined acoustic model/settings of step 220. The method can then reiterate, returning to step 205, in order to dynamically adjust operational settings based on changed in the acoustic environment.

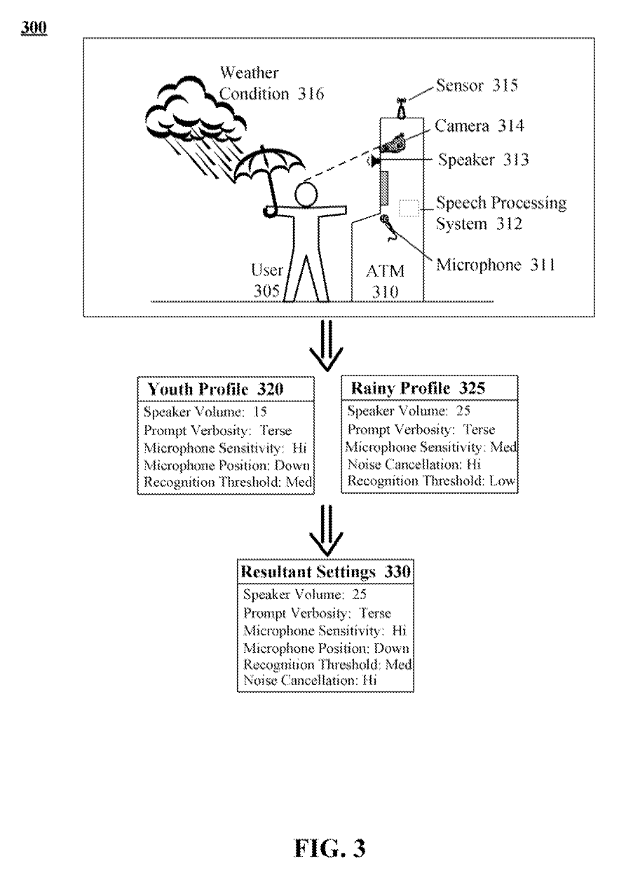

FIG. 3 is a graphical representation 300 illustrating how a speech processing system can use external inputs to adjust operations in accordance with an embodiment of the inventive arrangements disclosed herein. The example illustrated in the graphical representation 300 can utilize system 100 and/or method 200.

In this graphical representation 300, a user 305 can attempt to perform a transaction with a voice-enabled ATM 310. The ATM 310 can be equipped with a microphone 311 for collecting speech input, a speech processing system 312, a speaker 313 for producing speech output, a camera 314, and one or more sensors 315. The speech processing system 312 can be representative of the speech processing system 125 of system 100. The ATM 310 can use these components to collect and process data to adjust operations according to user and environmental conditions.

The sensor 315 can represent a variety of instruments to detect various environmental conditions. For example, the sensor 315 can include a hygrometer to measure the humidity level around the ATM 310 to determine if the current weather condition 316 is rainy. The sensor 315 could also include an anemometer to measure the wind speed that the ATM 310 is being subjected to. The data collected by the sensor 315 can be passed to the speech processing system 312 for further processing.

Many ATMs 310 are already equipped with a camera 314 for security purposes. The camera 314 can also be used to collect general user data that can be utilized by the speech processing system 312. As shown in this example, the camera 314 can be used to determine the height of the user 305, indicated by the dotted line. This information can indicate that the user 310 is a younger person. A determination of a general age grouping can also be performed by sampling voice input captured by the microphone 311. Characteristics, such as pitch and timber, can be used by the speech processing system 312 to determine user 310 characteristics such as age and gender.

In one embodiment, the camera 314 or other sensor 315 can be used to determine a length of a line of people waiting to use the ATM 310. When the line is relatively long, the system 312 can be adjusted from a normal prompting state to a terse prompting state, which can be associated with a “rushed user” profile or an “expedited service” profile. The expedited service profile can result in presented ATM 310 options being minimized, a verbosity of prompts being decreased, a speaking rate of speech output increasing, and the like.

The data collected by the components of the ATM 310 can result in the speech processing system 312 determining that a youth profile 320 and rainy profile 325 are applicable to this user 305 and weather condition 316. As shown in this example, both the youth profile 320 and rainy profile 325 can have settings that overlap, such as speaker volume and prompt verbosity, as well as unique settings, such as microphone position and noise cancellation.

The speech processing system 312 can apply associated rules to these profiles to determine a set of resultant settings 330. As shown in this example, the resultant settings 330 include all items from each profile as well as the highest setting in the cases where both profiles 320 and 325 contained the item. The resultant settings 330 can then be used to adjust the operation of the ATM 310 and its components.

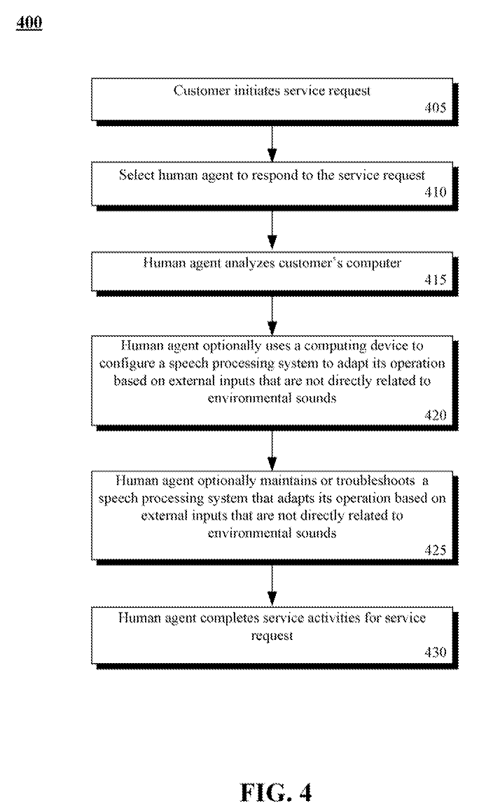

FIG. 4 is a flow chart of a method 400 where a service agent can configure a speech processing system to adapt its operation based on external inputs that are not directly related to environmental sounds in accordance with an embodiment of the inventive arrangements disclosed herein. Method 400 can be performed in the context of system 100 and/or method 200.

Method 400 can begin in step 405, when a customer initiates a service request. The service request can be a request for a service agent to provide a customer with a new speech processing system that can adapt its operation based on external inputs that are not directly related to environmental sounds. The service request can also be for an agent to enhance an existing speech processing system with the capability to adapt operations based on external inputs. The service request can also be for a technician to troubleshoot a problem with an existing system.

In step 410, a human agent can be selected to respond to the service request. In step 415, the human agent can analyze a customer's current system and/or problem and can responsively develop a solution. In step 420, the human agent can use one or more computing devices to configure a speech processing system to adapt operations based on external inputs that are not directly related to environmental sounds. This step can include the installation and configuration of an external input processor and input-to-profile converter as well as the creation of operational profiles.

In step 425, the human agent can optionally maintain or troubleshoot a speech processing system that uses external inputs to adjust operations. In step 430, the human agent can complete the service activities.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A speech processing system comprising:
an acoustic environment including at least one microphone for receiving speech input;
a speech processing system configured to receive speech input, to automatically performing a set of programmatic actions based upon the speech input, and to present output resulting from the programmatic actions;
an external input processor configured to receive non-sound input relating to the acoustic environment and to match the received input to a related profile; and
a setting adjustor configured to automatically adjust settings of the speech processing system based upon a profile determined based upon input processed by the external input processor.

2. The system of claim 1, wherein the acoustic environment further comprises at least one speaker for audibly presenting speech output, and wherein the output of the speech processing system includes speech output presented via the at least one speaker.

3. The system of claim 1, wherein the automatically adjusted settings comprise at least one of establishing a customized noise filtering algorithm and establishing a customized set of recognition confidence threshold.

4. The system of claim 1, further comprising:
a sensor worn by a user of the system, said sensor providing the speech processing system with user specific non-sound input, which is processed by the external input processor.

5. The system of claim 1, further comprising:
an sensor located in the acoustic environment for measuring a weather condition, wherein said sensor generates the non-sound input, said sensor comprising at least one of a hygrometer, an anemometer, a barometer, and a thermometer.

6. The system of claim 1, further comprising:
a server remotely located from the speech processing system and from the acoustic environment, which is communicatively linked to the speech processing system, wherein the non-speech input from the server includes dynamic data that is specific to a location proximate to the acoustic environment.

7. The system of claim 6, wherein the dynamic data is related to weather.

8. The system of claim 1, wherein the non-sound input includes real-time physiological input for a user of the speech processing system, where the user is located in the acoustic environment.

9. The system of claim 1, wherein the non-sound input includes weather based input.

10. The system of claim 9, wherein said acoustic environment is an outdoor environment, wherein the adjustments made by the setting adjustor include optimizing an acoustic model corresponding to weather conditions of the outdoor environment.

11. A method for adapting speech processing settings comprising:
receiving real-time input associated with at least one of an acoustic environment and a user of a speech processing system, wherein said real-time input is non-speech input;
determining a previously established profile from a set of profiles that matches the received input, wherein the profile is associated with at least one setting of the speech processing system; and
dynamically and automatically adjusting at least one setting.

12. The method of claim 11, further comprising:
iteratively repeating the receiving, determining, and adjusting steps.

13. The method of claim 11, wherein the real-time input includes at least one of physiological input associated with the user and weather input associated with the acoustic environment.

14. The method of claim 11, wherein the real-time input is weather related input obtained from a sensor located proximate to the acoustic environment, said sensor comprising at least one of a hygrometer, an anemometer, a barometer, and a thermometer.

15. The method of claim 11, wherein the real-time input is conveyed from a server remotely located from the speech processing environment and the speech processing server, said real-time input being specific to a location proximate to the acoustic environment.

16. The method of claim 11, wherein the adjusting step further comprises at least one of:
adjusting a customized noise filtering algorithm;
adjusting at least one recognition confidence threshold of the speech processing system; and
adjusting an acoustic model related to the acoustic environment, upon which acoustic settings of the speech processing system are based.

17. The method of claim 11, wherein the steps of claim 11 are performed by at least one of a server agent and a computing device manipulated by the service agents, the steps being performed in response to a service request.

18. The method of claim 11, wherein said steps of claim 11 are performed by at least one machine in accordance with at least one computer program having a plurality of code sections that are executable by the at least one machine.

19. A method of automatically adjusting settings of a speech processing system comprising:
determining at least one weather condition affecting an acoustic environment from which speech input for a speech processing system is received; and
automatically adjusting at least one setting of the speech processing system to optimize the system in accordance with the determined weather condition.

20. The method of claim 19, further comprising:
establishing a plurality of profiles for different weather conditions, each profile being associated with a set of speech processing settings; and
selecting one of the plurality of profiles based upon the determined at least one weather condition, wherein the at least one setting of the adjusting step is the set of speech processing settings associated with the selected profile.
